(19) United States
(12) Patent Application Publication
(10) Pub. No.: US 2023/0177914 A1
(43) Pub. Date: Jun. 8, 2023

(54) VIRTUAL TICKETING FOR CASHLESS GAMING

(71) Applicant: SG Gaming, Inc., Las Vegas, NV (US)

(72) Inventors: Murali JESUDOSS, Jacksonville, FL (US); Robert J. RANDEL, Northfield, NJ (US); Kathiravan PALANISAMY, Marietta, GA (US)

(21) Appl. No.: 18/070,527

(22) Filed: Nov. 29, 2022

Related U.S. Application Data
(60) Provisional application No. 63/285,375, filed on Dec. 2, 2021.

(51) Int. Cl. G07F 17/32; G06Q 20/10; G06Q 20/02; G06Q 20/40

(52) U.S. Cl. CPC G07F 17/3225; G07F 17/3241; G07F 17/3223; G07F 17/3251; G06Q 20/10; G06Q 20/02; G06Q 20/4012

(57) ABSTRACT

A system and method(s) for cashless funding of a gaming machine is described. The method, for instance, includes detecting a user input associated with a funding request. The user input is transmitted from a mobile device. The method further includes, in response to detecting the user input, obtaining a virtual ticket from a third-party funding system external to a casino network. The virtual ticket was purchased, via the third-party funding system, from a ticketing server internal to the casino network. The virtual ticket is associated with a voucher identifier authorized by the ticketing server. The method also includes redeeming, using the voucher identifier, the virtual ticket. In response to redeeming the virtual ticket, the ticketing server transmits, via the casino network, a funding authorization for the amount of monetary value. The method further includes, in response to the receiving the funding authorization via the casino network, funding the gaming machine via funds transfer in the casino network.

### RELATED APPLICATIONS

This patent application claims priority benefit to U.S. Provisional Patent Application No. 63/285,375, filed Dec. 2, 2021. The disclosure of the 63/285,375 Application, is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2021, SG Gaming, Inc.

### FIELD OF THE INVENTION

The present invention relates generally to apparatus and methods for game funding and redemption, such as via ticketing.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines as well as those machines, or systems, that are easy to use. Funding a gaming session for a gaming machine has typically been performed using a form of physical value, such as cash or physical vouchers. However, many patrons find value in being able to fund gaming sessions without the use of cash or physical vouchers. Hence, shrewd operators consequently strive to employ the most entertaining, exciting, and useful machines, features, and enhancements available because such machines and/or features attract frequent play, provide ease of use, and increase profitability to the operator. Therefore, there is a continuing need for wagering game machine manufacturers to continuously develop new games, gaming enhancements, and gaming features (e.g., cashless gaming features) that will attract frequent play.

A need therefore exists for an apparatus and methods to overcome these, and similar, challenges.

### SUMMARY

According to an embodiment of the present disclosure, a system to detect, via a wireless communication device communicatively coupled to a player interface device, a user input transmitted from a mobile device. The player interface device is communicatively coupled to a gaming machine. The mobile device is communicatively coupled to a third-party funding system via a telecommunications network. The user input is associated with a request to fund the gaming machine with an amount of monetary value. The system can further obtain, in response to detection of the user input, a virtual ticket purchased, via the third-party funding system, from a ticketing server. The ticketing server is communicatively coupled to the casino network. The virtual ticket is associated with a voucher identifier authorized by the ticketing server. The system can further redeem, using the voucher identifier, the virtual ticket. In response to redemption of the virtual ticket, the ticketing server is configured to transmit, via the casino network, a funding authorization. Furthermore, the system can, in response to the receipt of the funding authorization via the casino network, fund, via funds transfer, the gaming machine with the amount of monetary value.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a diagram of an example system according to one or more embodiments of the present disclosure.

FIG. 2 illustrates an example flow chart according to one or more embodiments of the present disclosure.

FIG. 3 illustrates an example data flow according to one or more embodiments of the present disclosure.

FIG. 4 is an illustration of cashless funding of a gaming machine according to one or more embodiments of the present disclosure.

FIG. 5 is an illustration of cashless funding of a gaming machine according to one or more embodiments of the present disclosure.

FIG. 6 is a diagram of an example system according to one or more embodiments of the present disclosure.

FIG. 7 illustrates an example data flow according to one or more embodiments of the present disclosure.

FIG. 8 is a schematic view of a gaming system according to one or more embodiments of the present disclosure.

FIG. 9 is a block diagram of a computer system 900 according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings, and will herein be described in detail, preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

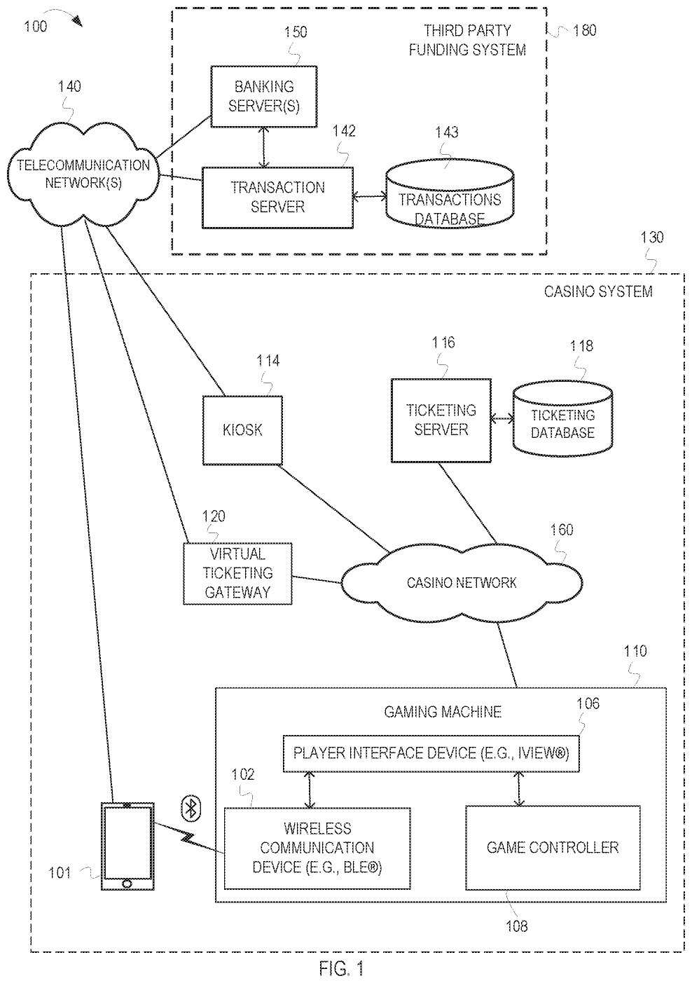

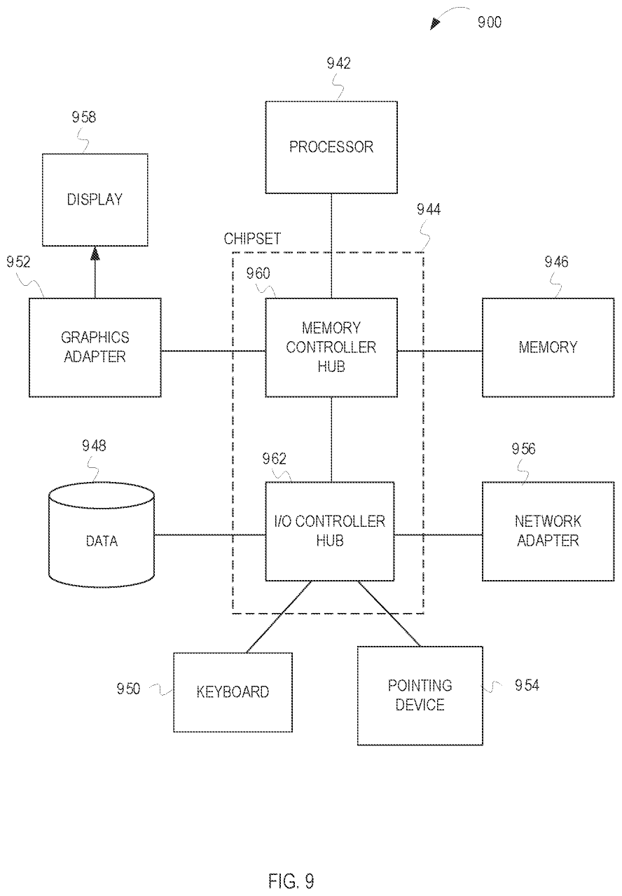

FIG. 1 is a diagram of an example system 100 according to one or more embodiments of the present disclosure. The system 100 includes a third-party funding system 180, which includes a transaction server 142 communicatively coupled to a transaction database 143 and to one or more banking servers 150 (e.g., via one or more telecommunication networks (“telecommunication network(s) 140”)). In some embodiments, the telecommunication network(s) 140 include, but are not limited to, the Internet, a computer network, a cell phone communication network, etc. The transaction server 142 is communicatively coupled to a kiosk 114 via the telecommunication network(s) 140. The kiosk 114 is communicatively coupled to a ticketing server 116 via a casino network 160. The kiosk 114 is associated with (e.g., located within, controlled by, authorized for use in) a casino system 130. The casino system 130 also includes the ticketing server 116, which is communicatively coupled to a ticketing database 118. Further, a gaming machine 110 is communicatively coupled to the ticketing server 116 and a virtual ticketing gateway 120 via the casino network 160. The virtual ticketing gateway 120 is communicatively coupled (via the casino network 160) to a player interface device 106. The virtual ticketing gateway 120 is also communicatively coupled (via the telecommunication network(s) 140) to the transaction server 142. The virtual ticketing gateway 120 may be a server, a desktop computer, a laptop, a smartphone, a gaming machine, or other form of electronic device having one or more processors, a computer memory, an electronic communications system (e.g., a bus, a network interface device, a wireless communications device, etc.), etc. For instance, the virtual ticketing gateway 120 may be the computer system 900 described in FIG. 9. In some embodiments, the virtual ticketing gateway 120 is configured to receive instructions from the player interface device 106 pertaining to redemption of virtual tickets. Further, the virtual ticketing gateway 120 is configured, and authorized, to coordinate communications with the transaction server 142 and with the ticketing server 116 to create and/or redeem virtual tickets (e.g., to create, modify and/or cancel voucher records associated with virtual tickets). In addition, the virtual ticketing gateway 120 is configured to transmit authorization instructions to the player interface device 106 to fund the game controller 108 via funds transfer. Further, the virtual ticketing gateway 120 is configured to track and maintain a transaction history for operations and transactions that occur via communications with the transaction server 142, the ticketing server 116, the player interface device 106, etc. For instance, the virtual ticketing gateway 120 is configured to facilitate error handling for transactions. Further, in some embodiments, the virtual ticketing gateway 120 can aggregate data related to transactions with the third party funding system 180 as well as transactions that occur by various devices of the casino system 130. The virtual ticketing gateway 120 can generate reports based on the transaction data.

The gaming machine 110 includes a wireless communication device 102, such as a personal area network (WPAN) device configured to communicate via a short-range, wireless protocol (e.g., via Bluetooth® technology). In one example, the wireless communication device 102 is a Bluetooth Low Energy (BLE) device. In some examples, the wireless communication device 102 is a mobile (or wireless) card reader (e.g., a modular card reader) with wireless proximity sensing capabilities and that supports wireless Bluetooth™ type communications. In some embodiments, the wireless communication device 102 is configured to connect (e.g., via wireless authentication) to a mobile device 101 (e.g., a smartphone, a tablet, a personal mobile device, etc.) which is associated with a casino patron (i.e., with a player of the gaming machine 110). The mobile device 101 is configured to present a mobile application from which a registered patron can provide user input. The mobile application is associated with gaming credits that were purchased via the third-party funding system 180. According to some embodiments, a software development kit (SDK) of the player interface device 106 is integrated with the mobile application for purposes of communication with the wireless communication device 102.

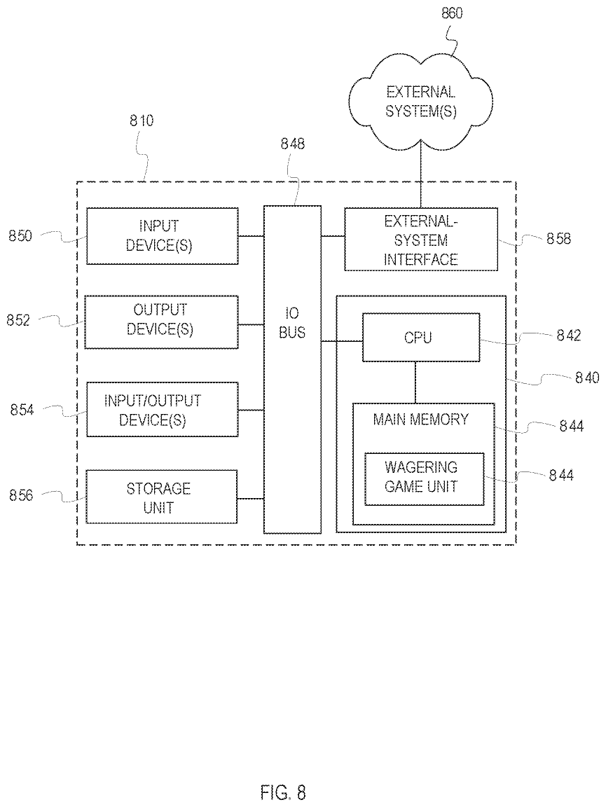

The wireless communication device 102 is communicatively coupled to other devices within the gaming machine 110. For instance, in one embodiment, the wireless communication device 102 is communicatively coupled to the player interface device 106 (e.g., via a Universal Serial Bus (USB) connection). In some embodiments, the wireless communication device 102 communicates with the player interface device 106 via an encrypted communication channel. In some embodiments, the player interface device 106 is communicatively coupled to the game controller 108 and is configured to communicate with the game controller 108. In some embodiments, the player interface device 106 can intercept an image feed of gaming content from the game controller 108 and rescale the gaming content to fit as a picture-in-picture within a player user interface that presents content related specifically to a player account (such as customer loyalty benefit information, earned rewards points, player funds, promotions, bonus games, etc.). The player interface device 106 can also provide access to casino services such as electronic drink deliveries, ordering tickets to casino entertainment, redeeming rewards, etc. Further, in some embodiments, the player interface device 106 is configured to communicate with the virtual ticketing gateway 120. In some embodiments, the player interface device 106 is an iView® player interface product by Scientific Games Corporation. An example description of the iView® product can be found in United States (U.S.) Pat. No. 8,241,123 to Kelly et al., the entirety of which is hereby incorporated by reference. The gaming machine 110 also includes a game controller 108. Examples of various devices, including a gaming machine and/or pairing of a gaming machine to a Bluetooth device, are described in detail in U.S. Pat. No. 10,643,431 to Chesworth et al., and/or U.S. Pat. No. 10/068,417 to Toohey et al.. The U.S. Pat. No. 8,241,123 and U.S. Pat. No. 10/068,417, which are hereby incorporated by reference in their respective entireties. In some embodiments, the gaming machine 110 may be the example gaming machine 810 described in FIG. 8.

The third-party funding system 180 is associated with one or more funding entities external to the casino system 130. For instance, the transaction server 142 is connected to one or more banking servers 150 that provide funds with which a registered patron (e.g., a player) can purchase gaming credits. One example of the transaction server 142 can be found in U.S. Patent Application Publication No. 2021/0104118, for U.S. patent application Ser. No. 17/029,899 to Schwartz, the entirety of which is hereby incorporated by reference. The transaction server 142 includes validation circuitry that enables the registered patron to use the mobile device 101 to purchase gaming credit for use at the gaming machine 110. Prior to the patron making a funding request to play the gaming machine 110, the patron registers with the transaction server 142, which creates entries associated with the patron in the transactions database 143. The entries may be referred as a profile. In some instances, the profile is associated with a unique identifier, such as a unique mobile device identifier (e.g., a cell phone ID associated with the mobile device 101). The profile may further be associated with information for the patron regarding one or more funding sources (for example, without limitations, credit or debit card bank accounts, existing gaming vouchers stored in the ticketing database 118, or an e-wallet). In some instances, the profile includes authentication information for the patron (for example, without limitation, a PIN (personal identification number), finger print, thumb print, voice print, face print, retina print, transaction DNA, block chain, token, and/or certificate associated with the patron).

The transaction server 142 stores and retrieves data pertaining to transactions in the transactions database 143. In some embodiments, the transaction server 142 maintains in the transactions database 143, for each registered patron, one or more records that indicate transactions associated with the patron using the mobile device 101. Each transaction record (in the transactions database 143) includes the mobile identifier, the voucher ID of the virtual ticket created for the transaction, the monetary value of the transaction, and a date-and-time stamp for the transaction. In some embodiments, the transaction record also indicates a type of the transaction (e.g., crediting a gaming machine vs. other types of transactions) and a location associated with the transaction (e.g., a tag ID of the gaming machine, a GPS location, etc.). With at least one viable funding source registered with the transaction server 142, the patron is able to use his mobile device 101 to purchase gaming credit to play the gaming machine 110. In some embodiments, unlike a conventional virtual or electronic wallet (aka e-wallet), at no time during the described process(es), do the funds associated with the gaming credit reside on the mobile device 101 itself or in an account associated with the patron. Moreover, in some embodiments, at no time does the mobile device 101 or the patron have access to the voucher ID of any gaming voucher purchased by the patron or on behalf of the patron using the mobile device 101.

In some embodiments, the mobile device 101 transmits a touchpoint identifier for the gaming machine 110 to the transaction server 142, which communicates with the ticketing server 116 to create a voucher for the gaming credit. In some embodiments, the transaction server 142 communicates with the ticketing server 116 via the kiosk 114. In some embodiments, the transaction server 142 communicates with the ticketing server 116 using communication protocols that facilitate kiosk communications, slot accounting and ticketing (e.g., for generating a voucher identifier (voucher ID), such as those associated with Ticket-In-Ticket-Out (TITO) vouchers). In other embodiments, the transaction server 142 is configured to communicate directly with the ticketing server 116 (e.g., via the telecommunication network(s) 140 and/or via the casino network 160). In some embodiments, the communication protocols are those used by a casino management system (or a casino accounting system). Some examples of casino management systems include, but are not limited to, the ACSC™ Casino Management System by Scientific Games Corporation or the SDS™ Slot Management System by Scientific Games Corporation. The transaction server 142 can further transmit a transaction package for the purchased gaming credit to the mobile device 101. The transaction package includes a voucher ID.

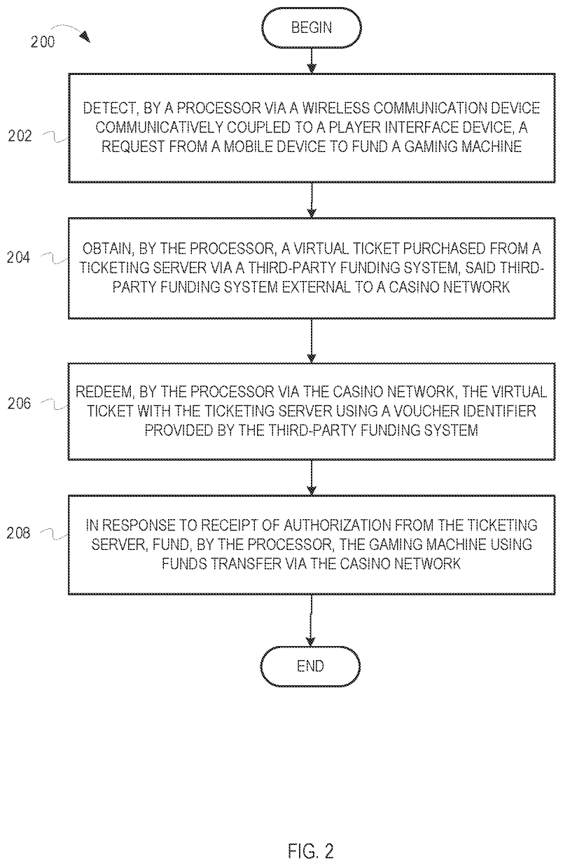

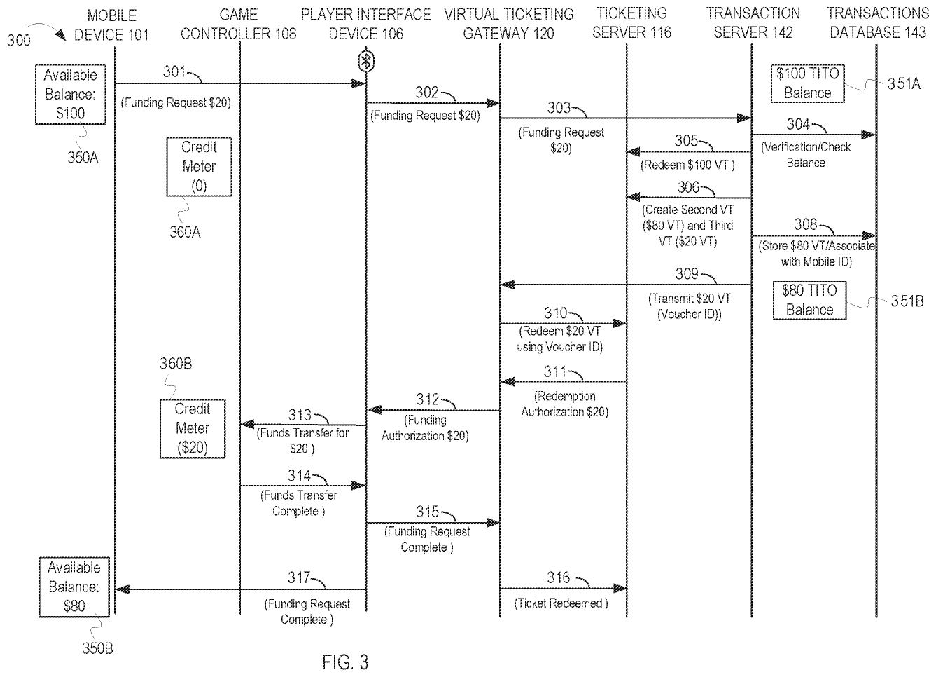

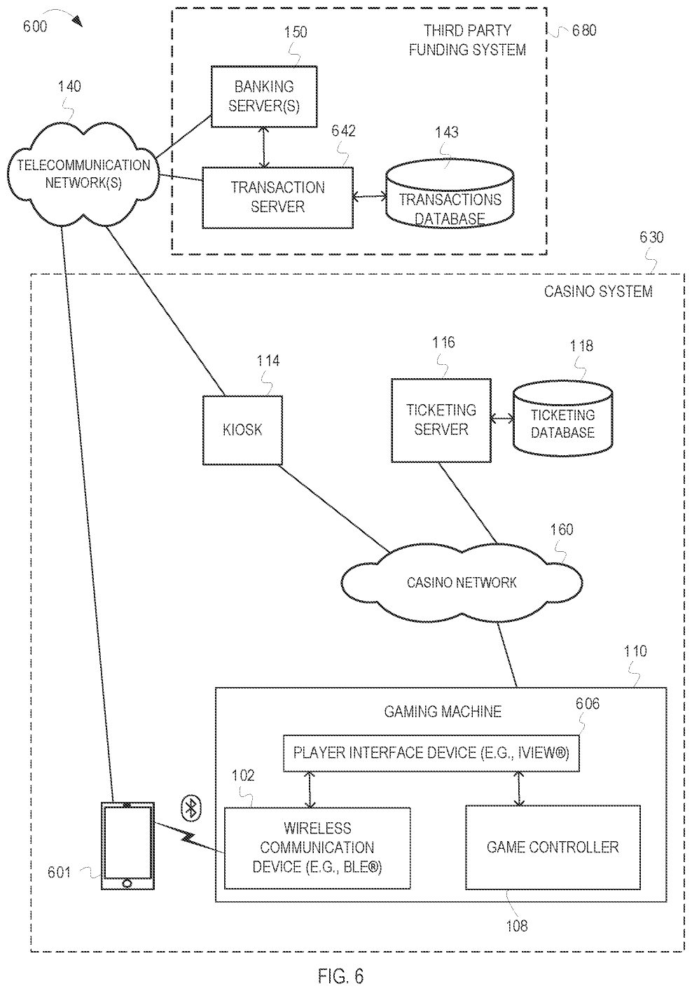

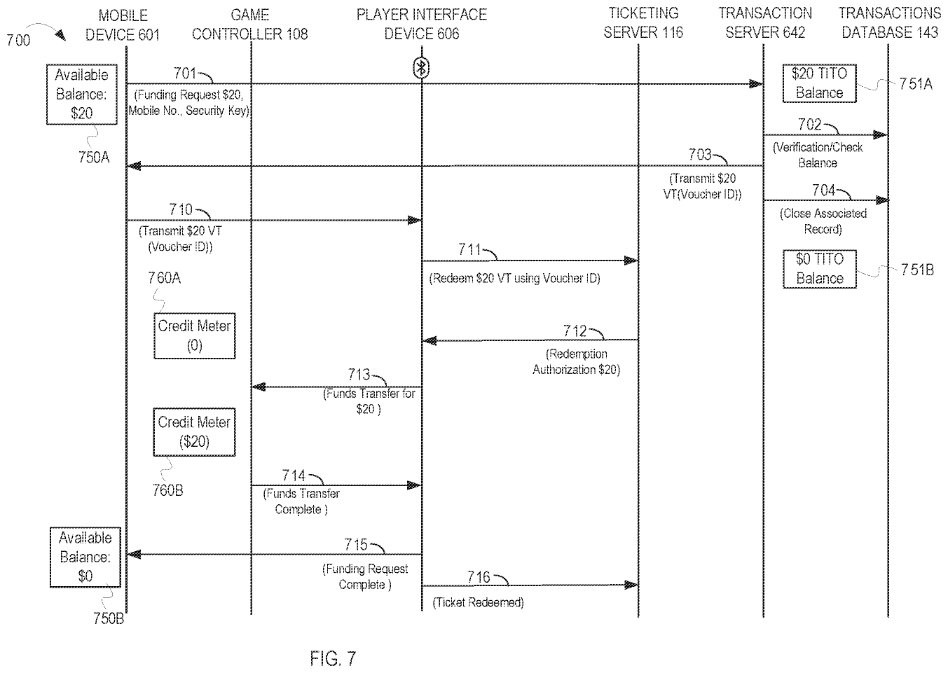

One way to redeem the voucher, without requiring the use of a bill validator at the gaming machine 110, includes using a device (or combination of devices), internal to the casino network 160, to access the third-party funding system 180, obtain a virtual ticket (e.g., obtain a virtual voucher ID), redeem the virtual ticket (e.g., authorize, using the virtual voucher ID, redemption via the ticketing server 116), and complete a fund transfer (e.g., via a player interface device 106) to the gaming machine 110 (e.g., to the game controller 108). One example of a device for virtual ticket redemption internal to the casino network 160 includes the virtual ticketing gateway 120. For example, in some embodiments, after the transaction server 142 provides funds from the banking server(s) 150, the virtual ticketing gateway 120 can access the purchased gaming credits (i.e., funds) from the third-party funding system 180 (which purchased credits are associated with a specific voucher ID stored in association with the transaction database 143 and the ticketing database 118). The virtual ticketing gateway 120 communicates the authorization to redeem the desired amount of gaming credits to the player interface device 106, which in turn uses a protocol for electronic transfer of funds (referred to herein as “funds transfer”) to add the portion of the redeemed value from the virtual ticket to a credit meter (of the gaming machine 110). The protocol for the funds transfer includes, but is not limited to, the Advanced Funds Transfer (AFT) protocol or the Electronic Funds Transfer (EFT) protocol. AFT is a secure technology for transferring funds between a gaming machine and a casino accounting system. AFT can be used to transfer funds associated with player tracking accounts. Further, AFT can be used for promotional ticketing. The player interface device 106 is configured to communicate with the virtual ticketing gateway 120 and/or the ticketing server 116 via the casino network 160. In other words, the virtual ticketing gateway 120 accesses purchased gaming credits (stored in association with a voucher ID by the third-party funding system 180) and electronically transfers (via the player interface device 106) the value of the purchased credits to the gaming machine 110 via funds transfer within the casino network 160 without requiring use of a bill validator . For example, the player interface device 106 can control and communicate data (e.g., gaming credit information) directly to the game controller 108 via Slot Accounting System (SAS) communication protocols and functionality, which includes the funds transfer capabilities. Thus, the virtual ticketing gateway 120 facilitates the control and communication of the purchased gaming credit using the funds transfer capabilities of the player interface device 106. In some embodiments, the virtual ticketing gateway 120 and the player interface device 106 may be combined into a single device (as described in FIG. 6 an FIG. 7). In some embodiments, the virtual ticketing gateway 120 facilitates the control and communication of the purchased gaming credit, as described in one or more of FIG. 2. or FIG. 3.

FIG. 2 illustrates an example of a method of according to one or more embodiments of the present disclosure. The description of FIG. 2 refers to a “processor” that performs operations associated with the flow 200. In some embodiments, the processor is included in, or associated with, a virtual ticketing gateway (e.g., virtual ticketing gateway 120 described in FIG. 1 and FIG. 3). In another embodiment, the processor is associated with a player interface device (e.g., player interface device 606 described in FIG. 6) in place of the virtual ticketing gateway 120. In FIG. 2, a method flow 200 begins at processing block 202, where a processor detects a request, transmitted from a mobile device, to fund a gaming machine. In some embodiments, the request is received via a wireless communication device. In some embodiments, the request (i.e., funding request) is associated with user input received via a mobile application running on the mobile device. The funding request also specifies a specific monetary amount. In some embodiments, the processor also detects, via the user input, a security key. Further, the processor detects, via communication with the mobile device, and a mobile device identifier for the mobile device. In some embodiments, the processor determines information associated with the funding request (e.g., the requested monetary value, the security key, the mobile device identifier, etc.) via an application programming interface (API) communication between the player interface device and a mobile application running on the mobile device. In some embodiments, the security key is one or more of a passcode or a personal identification number (PIN). One example of detecting a funding request is illustrated in FIG. 3 (e.g., see FIG. 3, processing blocks 301 through 302). Another example of detecting a funding request is illustrated in FIG. 7 (e.g., see FIG. 7, processing block 701).

Still referring to FIG. 2, the flow 200 continues at processing block 204, where in response to detecting the funding request, the processor obtains a virtual ticket. In some embodiments, the processor obtains the virtual ticket by determining the mobile device identifier, and transmitting, to the transaction server, a request to transfer the virtual ticket. In some instances, requesting the transfer includes providing to the transaction server the mobile device identifier and the security key for a verification of the request to transfer. In some instances, a copy of the mobile device identifier is stored in a transaction database record when the virtual ticket was purchased from the ticketing server. Thus, the transaction server verifies the request to transfer the funds by determining that the mobile device identifier, as determined by the player interface device, is equivalent to the copy of the mobile device identifier stored in the transaction database record. The processor further receives the voucher identifier from the transaction server in response to the transaction server verifying the request to transfer. FIG. 3 illustrates an example of obtaining the virtual ticket from the third-party funding system (e.g., see FIG. 3, processing blocks 303 through 309). FIG. 7 illustrates another example of obtaining the virtual ticket from the third-party funding system (e.g., see FIG. 7, processing blocks 702 through 710).

Referring still to FIG. 2, the flow 200 continues at processing block 206, where the processor redeems the virtual ticket from the ticketing server using a voucher identifier provided by the third-party funding system. In some embodiments, the processor transmits, to the ticketing server, a redemption command for the virtual ticket using the voucher identifier. In response to receiving the redemption command, the ticketing server generates a redemption authorization equivalent to the amount of monetary value. The processor receives, from the ticketing server, the redemption authorization. In some embodiments, in response to receiving the redemption authorization, the processor generates, and transmits to the player interface device, a funding authorization. For instance, FIG. 3 illustrates an example of redeeming the virtual ticket from the ticketing server using a voucher identifier (e.g., for details see FIG. 3, processing blocks 310 through 311). In another example, FIG. 7 illustrates redeeming the virtual ticket from the ticketing server using a voucher identifier (e.g., see FIG. 7, processing blocks 711 through 712).

Referring again to FIG. 2, the flow 200 continues at processing block 208, where, in response to receiving authorization from the ticketing server, the processor funds the gaming machine, via funds transfer on the casino network. For example, in some embodiments, in response to receiving the redemption authorization, the processor generates and transmits a funding authorization to the player interface device. The player interface device is configured to control the funds transfer of the amount of monetary value to a game controller of the gaming machine. In some embodiments, the processor is associated with a Slot Account System (SAS) host. Thus, the redemption command can comprise a first SAS command, and the funds transfer can comprise one or more second SAS commands. In some embodiments, the funds transfer comprises one or more of an Advanced Fund Transfer (AFT) or an Electronic Funds Transfer (EFT). FIG. 3 illustrates one example of funding a gaming machine via funds transfer (e.g., see FIG. 3, processing blocks 312 through 317). In another example, FIG. 7 illustrates funding a gaming machine via funds transfer (e.g., see FIG. 7, processing blocks 713 through 717).

In some embodiments the processor animates, via a display, information associated with the funding request, such as an indication of one or more of the redeeming the virtual ticket or the funding of the gaming machine. For example, the mobile application is configured to present (e.g., render, animate, etc.) an indication of the completion of the funding request via a user interface and/or display of the mobile device 101. For instance, in some embodiments, the processor generates, via the player interface device, a message indicating redemption of the amount of monetary value. The processor further transmits, via the wireless communication device, the message (i.e., redemption message) to the mobile device. The mobile device is configured to present the redemption message via a mobile application running on the mobile device. The processor can further transmit, via the player interface device, the redemption message to a game controller of the gaming machine. The game controller is configured to increase a credit meter with a number of gaming credits equivalent to the amount of monetary value specified in the funding request.

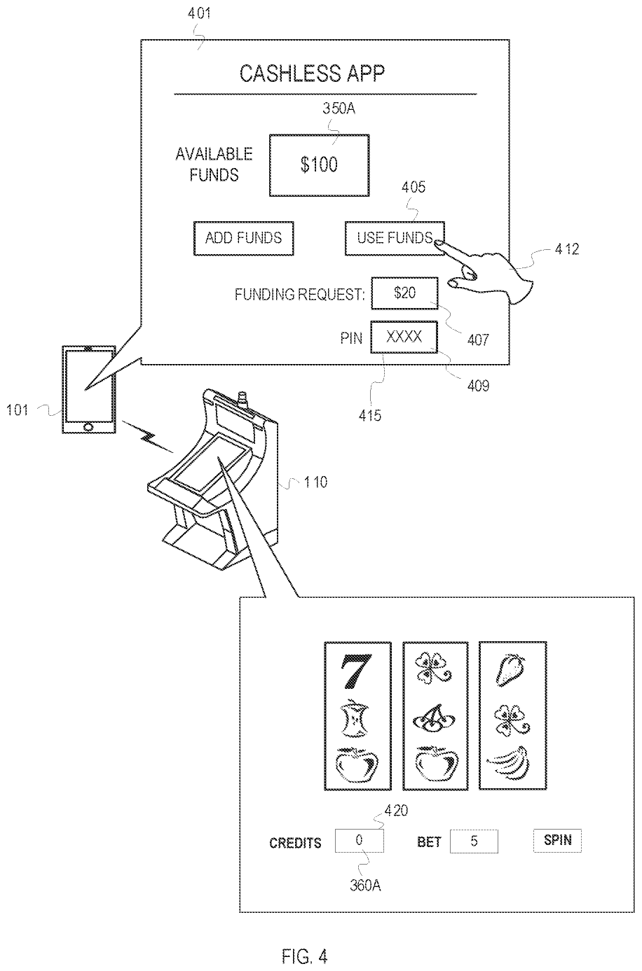

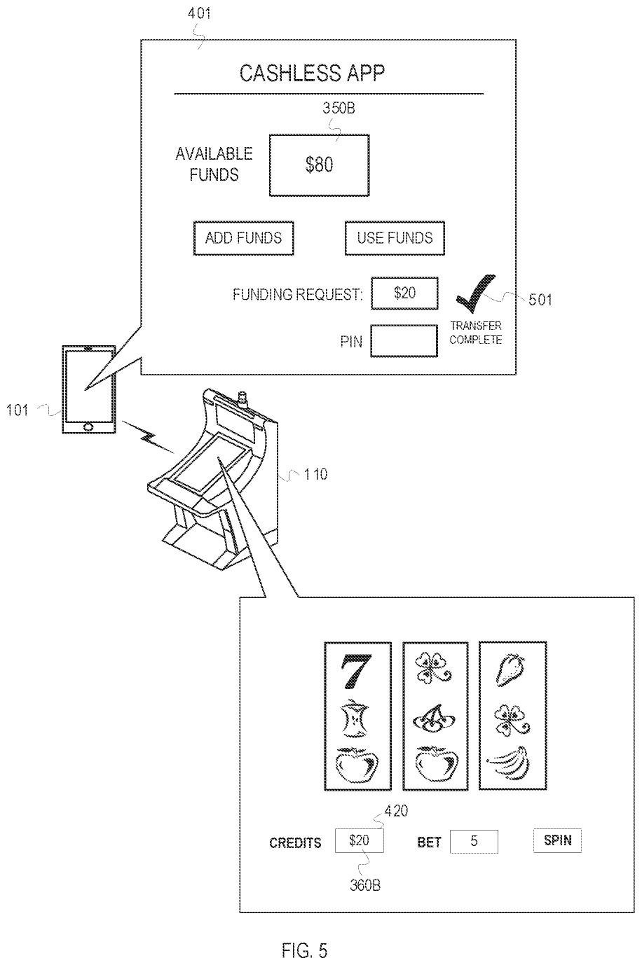

FIG. 3 illustrates an example data flow 300 according to one or more embodiments of the present disclosure. FIG. 1, FIG. 4, and FIG. 5 will be referenced in the description of FIG. 3. For ease of reference, some the reference numerals from FIG. 1 are included in FIG. 3. Furthermore, it should be noted that the data flow 300 shows an example of a funding request for an amount that is less than a balance of funds associated with a patron or profile. For example, the data flow 300 is for a funding request of $20 of value to be transferred from one or more records associated with the mobile identifier to the gaming machine 110. The balance of funds is stored in association with the mobile identifier or profile, which is tracked by the third party funding system 180. The transaction server 142 stores the balance of funds in one or more records of the transactions database 143 that are associated with the mobile device identifier. However, the balance of funds available to the patron is greater than the requested amount (i.e., the balance of funds is $100, which is greater than the $20 that was requested). Thus, the example shown in FIG. 3 splits a virtual ticket, worth $100, into two new virtual tickets (and two new separate voucher ID's) worth $80 and $20 respectively. The $20 ticket is then redeemed and transferred (e.g., via the virtual ticketing gateway 120) to the gaming machine 110. The $80 ticket is re-stored (e.g., via the transaction server 142) to the balance of funds tracked by the third party funding system 180. However, although the data flow 300 shows a virtual ticket being split, it should be noted that in other embodiments, the funding request may be equal to the value of a virtual ticket, in which case the virtual ticket is not split, but rather redeemed in its entirety and its entire value is transferred (e.g., via the virtual ticketing gateway 120) to the gaming machine 110.

Referring to FIG. 3, the data flow 300 begins at processing block 301 with detecting the funding request, by the mobile device, for at least a portion of monetary value associated with a balance of funds. The balance of funds is associated with at least one virtual ticket. The virtual ticket is an electronic credit voucher that is exchangeable for a certain amount of money within the casino system 130. The virtual ticket can be used to fund a gaming machine, which funds appear on the gaming machine as credits on a credit meter. The credits are used to play games (e.g., to place bets) on any gaming machine within the casino system 130, including the gaming machine 110 (or other gaming machines in the casino system 130 that are not shown). The virtual ticket can be printed and carried (as a printed ticket) to each gaming machine in the casino system 130. The printed ticket can be inserted into any gaming machine via a physical ticket reader. In other embodiments, however, the virtual ticket does not need to be printed for use. Rather, the mobile device 101 can track a balance of value for any virtual tickets purchased by the patron (e.g., via the mobile application) from the third-party funding system 180. The electronic data associated with virtual tickets is stored, by the ticketing server 116, in the ticketing database 118 via one or more database records. In some embodiments, each record is associated with one electronic credit voucher. These electronic records, thus, may also be referred to herein as virtual vouchers. The mobile device 101 can be physically taken to the gaming machine 110 and used to electronically fund the gaming machine 110 without needing to enter or scan a physical ticket at the ticket reader. For instance, once the mobile device 101 is within a specific distance or proximity to the wireless communication device 102, the mobile device 101 can initiate a pairing process with the gaming machine 110. Once paired (e.g., once authorized for secure communication with each other) a patron can use the mobile device 101 to electronically access the value of the virtual ticket(s) previously purchased by a patron (e.g., via the mobile application). In one embodiment, the mobile application shows the balance of value for the virtual tickets as a balance of funds specified in monetary value (e.g., in dollars) instead of as a collection of virtual tickets. Thus, a patron can specify (via the funding request) an amount of funds or monetary value (e.g., funding-request amount 407) to use from the balance of funds for transfer to the gaming machine 110. In some embodiments, the game controller 108 expresses the transferred amount of transferred funds as credits.

As mentioned, the mobile application is used to purchase virtual tickets. When a virtual ticket is being purchased, the transaction server 142 transmits the request for the virtual ticket to ticketing server 116 (e.g., via the kiosk 114). For instance, the patron requests to purchase a virtual ticket in the amount of $100. The transaction server 142 communicates with the banking server(s) 150 to transmit the amount of money (e.g., $100 from a patron's bank account or other source of funds) in exchange for the virtual ticket. In some embodiments, in response to receiving the request for the virtual ticket, the kiosk 114 transmits the request for the virtual ticket (along with an indication of the amount of money) to the ticketing server 116 via the casino network 160. The ticketing server 116 generates a first virtual ticket having a monetary value equivalent to the indicated amount of money (e.g., the virtual ticket is for $100). The ticketing server 116 creates the first virtual ticket by creating a voucher record for the first virtual ticket and storing the voucher record in the ticketing database 143. The ticketing server 116 returns a voucher ID for the first virtual ticket to the transaction server 142 (e.g., via the kiosk 114) for association with one or more transaction records. The mobile device 101 animates, via a display, a first available-balance value 350A indicating an available balance of funds equivalent to the monetary value of the first virtual ticket. For example, as illustrated in FIG. 4, when the mobile device 101 is positioned in sensing range of the wireless communication device 102 the wireless communication device 102 pairs with the mobile device 101. The pairing process establishes a wireless, encrypted communication link between the mobile device 101 and components of the gaming machine 110 (such as the player interface device 106). The wireless, encrypted communication link transmits application programming interface (API) calls from a mobile application 401 to the operating software of the player interface device 106. The mobile application 401 detects, via a user interface of the mobile device 101, at least one user input 412 that indicates a funding request for play of the gaming machine 110. For instance, as illustrated in FIG. 4, the user input 412 selects a control 405 to use a portion of the available funds specified by the first available-balance value 350A. The funding request specifies, via a user-input control 415, a specific amount (funding-request amount 407) to redeem from the first available-balance value 350A and transfer to the gaming machine 110 for use as gaming credits. A credit meter value 360A (for a credit meter 420 of the gaming machine 110) indicates a value of zero gaming credits before the funding request is completed. The mobile application 401 further determines a security key 409 (e.g., via the user input control 415). The security key 409 may include a passcode or personal identification number (PIN) associated with a patron or profile. The mobile device 101, in turn, transmits the funding request to the wireless communication device 102. The funding request specifies the desired amount to redeem (e.g., the funding-request amount 407). The funding request also specifies the security key 409 as well as a mobile device identifier (e.g., a mobile telephone number) associated with the mobile device 101. The mobile device identifier will be used by the transaction server 142 to associate any requests for redemption with a particular patron or profile. The transaction server 142 is configured to use the mobile device identifier to identify and access one or more database records stored in the transaction database 143 associated with the mobile device 101. In some embodiments, a separate device ID (e.g., for the mobile device 101) is also included in the funding request. The device ID can be a unique identifier value generated by the transaction server 142 when the mobile application is installed on the mobile device 101. The device ID can tie the identity of the mobile device 101 to a specific mobile device identifier. In response to detecting the user input 412 for the funding request, the mobile device 101 transmits the funding request to the wireless communication device 102. The wireless communication device 102 then communicates the funding request to the player interface device 106 (e.g., via USB connection).

Referring again to FIG. 3, the flow 300 continues at processing block 302 where the player interface device 106 receives the funding request and automatically transmits the funding request, via the casino network 160, to the virtual ticketing gateway 120.

The flow 300 continues at processing block 303 where the virtual ticketing gateway 120 receives the funding request, determines that the funding request is associated with the third-party funding system 180, and transmits the funding request to the transaction server 142. In some embodiments, the virtual ticketing gateway 120 determines that the funding request is associated with the third-party funding system 180 based on the information in the funding request and/or based on API transaction data that identifies the type or nature of the funding request as being related to the third party funding system 180. In response to determining that the funding request is associated with the third-party funding system 180, the virtual ticketing gateway 120 transmits the funding request to the transaction server 142 via the telecommunication network(s) 140. The virtual ticketing gateway 120 passes the information in the funding request (e.g., the requested amount to redeem ($20), the mobile device identifier, the security key, etc.) to the transaction server 142.

The flow 300 continues at processing block 304 where the transaction server 142 receives and verifies the funding request. For example, the transaction server 142 searches the transactions database 143 for any records associated with the information from the funding request, such as any records that indicate the mobile device identifier and/or device ID. The transaction server 142, for instance, determines that the funding request is associated with records that indicate the mobile device identifier and/or device ID. For example, the transaction server 142 determines that a specific record in the transactions database 143, associated with the mobile device identifier. indicates the first virtual ticket previously purchased (e.g., the specific record indicates the mobile device identifier, a voucher ID, and a monetary value associated with the voucher ID). The transaction server 142 determines that a balance of voucher funds 351A is sufficient to cover the funding request of $20. For example, the transaction server 142 determines that the specific record associated with the first virtual ticket indicates a voucher value of $100, which is greater than the $20 funding request. In some embodiments (e.g., as shown in FIG. 3) the $100 value for the first virtual ticket may be referred to as a $100 TITO balance. In some embodiments, the transaction server 142 uses the security key to access a profile for a patron that is associated with the first virtual ticket.

The flow 300 continues at processing block 305 where the transaction server 142 redeems the first virtual ticket. For example, the transaction server 142 transmits a redemption request for the first virtual ticket to the ticketing server 116 (e.g., via kiosk 114), to redeem the monetary value of the first virtual ticket. The redemption request indicates at least the voucher ID associated with the first virtual ticket. The ticketing server 116 replies to the request by redeeming the first virtual ticket and updating the accompanying record on the ticketing database 118. The ticketing server 116 transmits to the transaction server 142 (e.g., via kiosk 114) a message indicating the redemption of the first virtual ticket.

The flow 300 continues at processing block 306 where, in response to receiving the message indicating the redemption of the first virtual ticket, the transaction server 142 requests creation of a second virtual ticket and a third virtual ticket using portions of the monetary value received from redemption of the first virtual ticket. For example, the transaction server 142 subtracts the requested funding amount from the redeemed amount and requests the difference as a second virtual ticket. For instance, the transaction server 142 subtracts the desired $20 from the $100 redeemed amount and requests the second virtual ticket worth $80. The transaction server 142 submits the request for the second virtual ticket to the ticketing server 116 (e.g., via kiosk 114). The ticketing server 116 receives the request and generates the second virtual ticket worth $80. For example, in one embodiment, the ticketing server 116 generates a second record in the ticketing database 118 and associates a second voucher ID with the second record. The ticketing server 116 transmits the second voucher ID and an indication of the monetary value (i.e., the $80 value) to the transaction server 142 (e.g., via kiosk 114). The transaction server 142 creates the third virtual ticket for the amount of money indicated in the funding request. For example, the transaction server 142 can create a third record in the transactions database 143 and can write, to that third record, the mobile device identifier as well as data that indicates the originally requested amount of the funding request ($20). The third record is for the third virtual ticket. The transaction server 142 can also write, to the third record, the mobile device identifier as well as a third voucher ID.

The flow 300 continues at processing block 308 where the transaction server 142 stores the second virtual ticket in the transactions database 143. For example, the transaction server 142 can create a second record in the transactions database 143 and can write, to that second record, the mobile device identifier as well as data that indicates the monetary value of the second virtual ticket ($80). The mobile device identifier is written to the second record. Further, the transaction server 142 updates the balance of voucher funds 351A (e.g., which was a $100 TITO balance) to be an updated balance 351B (e.g., $80 TITO balance).

The flow 300 continues at processing block 309 where the transaction server 142 transmits the third virtual ticket to the virtual ticketing gateway 120. For example, the transaction server 142 transmits, to the virtual ticketing gateway 120, at least the third voucher ID. In some embodiments, the transaction server 142 also transmits an indication of the monetary value (i.e., $20), and any data required to identify the third virtual ticket with the funding request and/or to associate the third virtual ticket with the patron. For instance the transaction server 142 also transmits the mobile device identifier. Further, the transaction server 142 writes the monetary value in the third record (stored on the transaction database 143) to be a value of zero. In addition, because the third virtual ticket has been transmitted, then the transaction database 143 indicates an updated available-balance value (second available-balance value 350B). For instance, first available-balance value 350A (which was $100) changes to the second available-balance value 350B ($80) because the third ticket ($20) was transferred to the virtual ticketing gateway 120, and thus, regarding the patron's purchased virtual-ticket values, the transaction database 143 now only specifies the value of the second ticket ($80).

Referring back to FIG. 3, the flow 300 continues at processing block 310 where the virtual ticketing gateway 120 redeems the third virtual ticket using the voucher ID received from the transaction server 142. For example, the virtual ticketing gateway 120 transmits, via the casino network 160 to the ticketing server 116, a redemption request for the third virtual ticket. The virtual ticketing gateway 120 is authorized to transmit commands (e.g., SAS commands) to the ticketing server 116 to create or redeem virtual tickets. In some embodiments, the virtual ticketing gateway 120 uses similar communication protocols as the kiosk 114 for slot accounting and ticketing (e.g., for generating and/or redeeming virtual tickets).

The flow 300 continues at processing block 311 where, in response to receiving the redemption request for the third virtual ticket, the ticketing server 116 transmits a redemption authorization associated with third virtual ticket. For example, the virtual ticketing gateway 120 transmits a redemption command (e.g., a SAS redemption command) to the ticketing server 116 to redeem the third virtual ticket. The virtual ticketing gateway 120 also transmits any required information, such as the third voucher ID. The ticketing server 116 receives the redemption command and returns, to the virtual ticketing gateway 120, the redemption authorization. In some embodiments, the redemption authorization initiates a transaction between the virtual ticket gateway 120 and the ticketing server 116 that becomes closed only after receiving notification of successful redemption of the credits from the third virtual ticket (e.g., at processing block 316).

The flow 300 continues at processing block 312 where the virtual ticketing gateway 120 provides a funding authorization in response to redemption of the third virtual ticket. For example, in response to receiving the redemption authorization from the ticketing server 116, the virtual ticketing gateway 120 generates, and transmits, a funding authorization equivalent to the redeemed value ($20) of the third virtual ticket.

The flow 300 continues at processing block 313 where the player interface device transfers the redeemed value ($20) to the game controller 108 using one or more funds transfer commands. For example, in response to receiving the funding authorization, the player interface device transmits, to the game controller 108, a series of commands related to electronic transfer of cashable credits (e.g., AFT lock requests, AFT interrogation commands, AFT transfer requests, etc.). At least one of the funds transfer commands indicates the $20 value.

The flow 300 continues at processing block 314 where the game controller 108 adds gaming credits to a credit meter and then transmits a transfer completion response. For instance, in response to receiving the one or more funds transfer commands, the game controller 108 adds a number of cashable credits to the credit meter of the gaming machine 110. The number of cashable credits can depend on a game credit conversion factor associated with an accounting denomination specified for the gaming machine 110. For example, if the gaming device 110 is configured with an accounting denomination of five cents ($0.05), or in other words, the game credit conversion factor is five cents per game credit (e.g., $0.05/game credit), then the game controller 108 can multiply the $20 value by the $0.05/game credit conversion factor to obtain the number of cashable credits (e.g., one-hundred (100) cashable credits). In other embodiments, the game controller 108 indicates a number of credits equivalent to the monetary value (e.g., without a game credit conversion). For example, the game controller 108 adds twenty dollars ($20) of cashable credits to the credit meter. For example, as shown in FIG. 5, the credit meter 420 indicates an updated credit meter value 360B of “$20” in gaming credits. After adding the cashable credits to the credit meter, the game controller 108 transmits a transfer completion response that specifies that the game controller 108 was successfully funded with the credits.

Referring back to FIG. 3, the flow 300 continues at processing block 315, where, in response to receiving the transfer completion response, the player interface device 106 notifies the virtual ticketing gateway 120 that the funding request was completed.

The flow 300 continues at processing block 316 where, in response to receiving notification by the player interface device 106 that the funding request was complete, the virtual ticketing gateway 120 notifies the ticketing server 116 that the third virtual ticket was redeemed. In response to receiving notification that the funding request was complete, the ticketing server 116 is configured to close the record in the ticketing database 118 associated with the third virtual ticket. In other words, the ticketing server marks the record as being paid-out according to slot accounting protocols.

The flow 300 continues at processing block 317 where, in response to receiving the transfer completion response, the player interface device notifies the mobile device 101 that the funding request was completed. In some embodiments, as shown in FIG. 5, the mobile application 401 shows a notification 501 that the funding request was completed. The mobile application 401 also presents an updated balance value 350B showing that the previous balance value 350A was reduced by the amount of the funding request (e.g., the balance value 350A was $100, but was reduced by $20, so the updated balance value 350B indicates $80). Although the flows 200 and 300 illustrate some examples, in other embodiments, the configuration of some components of the casino system and/or the third-party system can vary. For example, in some embodiments, a bill-validator emulator is placed between an actual bill validator and the game controller 108. Thus, the virtual ticketing gateway 120 can communicate a voucher ID to the player interface device 106. The player interface device 106 can then transmit the voucher ID to the bill-validator emulator for redemption of the virtual ticket to the game controller 108.

In another embodiment, instead of using the wireless communication device 102, the mobile device 101 can instead transmit a funding request to a back-end server, such as to the virtual ticketing gateway 120, which in turn can communicate with the player interface device 106. The player interface device 106 communicates back to the virtual ticketing gateway 120, which in turn communicates with the mobile device 101. For instance, the mobile device 101 can scan a code associated with the gaming machine 110. The code may, for instance, be a QR code or 2D barcode. The code uniquely identifies the gaming machine 110 within the casino network 160. After the mobile device 101 scans the code, the mobile device 101 can transmit the scanned code to the virtual ticketing gateway 120 (e.g., via the telecommunications network(s) 140). The virtual ticketing gateway 120 can decipher the code and determine that it corresponds to the gaming machine 110. The virtual ticketing gateway 120 consequently establishes a secure channel of communication between the mobile device 101 and the player interface device 106.

In another embodiment, the ticketing server 116 and the virtual ticketing gateway 120 are combined into a single device configured to communicate with the player interface device 106.

In yet another embodiment, a player interface device is configured to perform some or all of the functionality of a virtual ticketing gateway. For instance, FIG. 6 is a diagram of an example system 600 according to one or more embodiments of the present disclosure. In FIG. 6, many of the elements shown in FIG. 1 are also included in FIG. 6 and perform similar functions and/or operations as described in connection with FIG. 1. However, some elements are configured differently, and therefore are referred to with different reference numbers. For example, in FIG. 6, a separate virtual ticketing gateway device is not shown because some or all of the hardware and/or software required to perform its required functionality and/or operations are included instead in a player interface device 606. The player interface device 606 is communicatively coupled to the wireless communication device 102 and the game controller 108 (e.g., via bus connections in the gaming machine 110). The player interface device 606 is also communicatively coupled to the ticketing server 116 via the casino network 160 (e.g., via a network interface device of the player interface device 606). In some embodiments, the player interface device 606 communicatively couples with to a mobile device 601 using the wireless communication device 102 (as described in FIG. 1). However, instead of a virtual ticketing gateway to communicate a funding request to the transaction server 642, the mobile device 601 is configured (e.g., via the mobile application) to communicate the funding request to the transaction server 642 via the telecommunications network 140. Furthermore, the transaction server 642 is configured to generate and transmit a transaction package (e.g., with encrypted transaction information, such as an encrypted voucher identifier and encrypted voucher monetary value) to the mobile device 601 via the telecommunication network(s) 140. In some embodiments, the mobile device 601 is configured to transmit the transaction package (with encrypted transaction information), but the mobile device 601 is unaware of the actual values of the encrypted values in the encrypted transaction information. Instead, the mobile device 601 is configured to deliver the encrypted transaction package to the player interface device 606 (e.g., via wireless communication device 102). The player interface device 606 (and/or the wireless communication device 102) are configured to receive the transaction package from the mobile device 601 and unpack the transaction package. For example, the player interface device 606 unbundles/decrypts values of the transaction package. The player interface device 606 can decrypt the transaction information using a stored key with a shared secret associated with the encryption generated by the transaction server 642. The transaction server 642 is similar to the transaction server 142 mentioned previously, with some configuration differences to communicate with the mobile device 601 in some ways that differ from the description of FIG. 1, for instance, to communicate the encrypted transaction package. The transaction server 642, transactions database 143, and banking servers 150 comprise the third party system 680. Likewise, player interface device 606 is similar to the player interface device 106 mentioned previously, with some configuration differences to communicate with the ticketing server 116 directly and also to communication with the mobile device 601 in some ways that differ from the description of FIG. 1, for instance, to receive and/or decrypt the transaction package. The player interface device 606, along with other devices connected to the casino network 160, comprise the casino system 630. The other devices include the mobile device 601, the kiosk 114, the ticketing server 116, the ticketing database 118, and the gaming machine 110.

FIG. 7 illustrates an example data flow 700 according to one or more embodiments of the present disclosure. The description of the flow 700 will reference FIG. 6.

Referring to FIG. 7, the data flow 700 begins at processing block 701 with detecting a funding request, by the mobile device 601, for at least a portion of monetary value associated with a balance of funds, and transmitting the funding request to transaction server 642. The balance of funds is associated with at least one virtual ticket. The mobile device 601 can track an available balance of funds (e.g. initial available-balance value 750A) for any virtual tickets purchased by the patron (e.g., via a mobile application) from the third-party funding system 680. Electronic data associated with virtual tickets (e.g., ticketing information) is stored, by the ticketing server 116, in the ticketing database 118 via one or more database records associated with one or more electronic credit vouchers, or virtual vouchers. A patron can specify (via a funding request) an amount of funds or monetary value to use from the initial available-balance value 750A for transfer to the gaming machine 110.

As mentioned, the mobile application is used to purchase virtual tickets. For instance, a patron can purchase, via the third party funding system 680, a virtual ticket in the amount of $20. To do so, the transaction server 642 communicates with the banking server(s) 150 to transmit the amount of money (e.g., $20 from a patron's bank account or other source of funds) to the ticketing server 116 (e.g., via kiosk 114) in exchange for the virtual ticket. The ticketing server 116 generates a virtual ticket having a monetary value equivalent to the indicated amount of money (e.g., the virtual ticket is for $20). The ticketing server 116 returns a voucher ID for the virtual ticket to the transaction server 642 for association with one or more transaction records in the transactions database 143. The mobile device 601 animates, via a display, the initial available-balance value 750A indicating an available balance of funds equivalent to the monetary value of the $20 virtual ticket. The mobile application further determines a security key. The security key may include a passcode or personal identification number (PIN) associated with a patron or profile. As mentioned, the mobile device 601 also transmits the funding request to the transaction server 642. The funding request specifies the desired amount to redeem (e.g., the $20). The funding request also specifies the security key as well as a mobile device identifier (e.g., a mobile telephone number) associated with the mobile device 601.

The flow 700 continues at processing block 702 where the transaction server 642 receives and verifies the funding request. For example, the transaction server 642 searches the transactions database 143 for any records associated with the information from the funding request, such as any records that indicate the mobile device identifier. For example, the transaction server 642 determines that a specific record in the transactions database 143 indicates the virtual ticket previously purchased. Thus, the transaction server 642 determines that a balance of voucher funds 751A (e.g., the $20 TITO balance of the virtual ticket) is sufficient to cover the funding request of $20. In some embodiments, the transaction server 642 uses the security key to access a profile for a patron that is associated with the virtual ticket.

The flow 700 continues at processing block 703 where the transaction server 642 transmits the virtual ticket to the mobile device 601. For example, the transaction server 642 generates and transmits a transaction package to the mobile device 601 via the telecommunication network(s) 140. In one embodiment, the transaction package contains an encrypted value representing the voucher ID. In one embodiment, the transaction package is a tokenized transaction package (TTP) message that contains an encrypted value representing at least the voucher ID. In some embodiments, the transaction package also contains an encrypted value of the monetary value of the virtual ticket. Those skilled in the art will understand how to select and apply a suitable encoding technique to generate encrypted values. Those skilled in the art will also understand that other implementations employ other suitable techniques for generating encrypted or unencrypted transaction packages. As used herein, the term “tokenized” implies that one or more sensitive data elements are represented in the TTP message by non-sensitive equivalents, referred to as tokens, which have no extrinsic or exploitable meaning or value. A token is a reference (i.e., identifier) that maps back to the sensitive data through a tokenization system. The mapping from original data to a token uses a method that renders tokens infeasible to reverse in the absence of the tokenization system. Thus, according to one implementation, tokenization is achieved using a suitable encryption technique that replaces sensitive data elements, such as the voucher ID (as well as any indicated monetary value), with corresponding encrypted values.

In one embodiment, the transaction server 642 encrypts the transaction package using a secret that is known to the player interface device 606 (and/or to the wireless communication device 102 associated with the player interface device 606). Thus, the player interface device 606 can decrypt and use the transaction information in the transaction package. In other embodiments, the transaction package is not encrypted prior to being transmitted.

The flow 700 continues at processing block 704 where the transaction server 642 closes the associated database record for the virtual ticket in the transactions database 143. For example, the transaction server 642 can change the value indicated on the database record from a value or $20 to a value of $0 (i.e., zeroes out the record). Further, the transaction server 642 updates the balance of voucher funds 751A (e.g., which was $20) to be an updated balance 751B (e.g., $0).

The flow 700 continues at processing block 710 where the mobile device 601 transmits the transaction package to the player interface device 606. As mentioned, in some embodiments, the transaction package includes encrypted transaction information and the mobile device 601 does not decrypt the transaction package. Therefore, in some embodiments, the mobile device 601 is unaware of the actual values of the encrypted transaction information in the transaction package. Rather, in some embodiments, the mobile device 601 is configured to forward the transaction package to the player interface device 606 via the wireless communication device 102. In one example, once the mobile device 601 is within a specific distance or proximity to the wireless communication device 102, the mobile device 601 can initiate a pairing process with the gaming machine 110. For instance, when the mobile device 601 is positioned in sensing range of the wireless communication device 102 the wireless communication device 102 pairs with the mobile device 601. The pairing process establishes a wireless, encrypted communication link between the mobile device 601 and components of the gaming machine 110 (such as the player interface device 606). The wireless, encrypted communication link transmits the transaction package using application programming interface (API) calls from the mobile application to the operating software of the player interface device 606. For instance, the user input specifies to use the funds indicated by the initial available-balance value 750A.

At this point in the flow 700, on the gaming machine 110, a credit meter value 760A indicates a value of zero gaming credits before the funding request is completed.

The flow 700 continues at processing block 711 where, the player interface device 606 receives the transaction package and transmits a redemption request to the ticketing server 116. In some embodiments, the player interface device 606 unbundles or decrypts the transaction package and determines the transaction information. For example, the player interface device 606 decrypts the transaction package using a stored key associated with the secret shared with the transaction server 642. Furthermore, the player interface device 606 determines, at least, the voucher identifier associated with the virtual ticket. The player interface device 606 then transmits a redemption request for the virtual ticket using the voucher identifier. In some embodiments, the player interface device 606 also includes, in the redemption request, a unique device identifier (e.g., a player-interface-device identifier or PIDI) that identifies the player interface device 606 as being associated with the gaming machine 110.

The player interface device 606 is authorized to transmit commands (e.g., SAS commands) to the ticketing server 116 to create or redeem virtual tickets. In some embodiments, the player interface device 606 uses similar communication protocols as the kiosk 114 for slot accounting and ticketing (e.g., for generating and/or redeeming virtual tickets).

The flow 700 continues at processing block 712 where, in response to receiving the redemption request for the virtual ticket, the ticketing server 116 transmits a redemption authorization associated with virtual ticket. For example, the player interface device 606 transmits a redemption command (e.g., a SAS redemption command) to the ticketing server 116 to redeem the virtual ticket. The player interface device 606 also transmits any required information, such as the voucher ID. The ticketing server 116 receives the redemption command and returns, to the player interface device 606, the redemption authorization. In some embodiments, the redemption authorization initiates a transaction between the player interface device 606 and the ticketing server 116 that becomes closed only after receiving notification of successful redemption of the credits from the virtual ticket (e.g., at processing block 716).

The flow 700 continues at processing block 713 where the player interface device 606 provides a funding authorization in response to redemption of the virtual ticket. For example, in response to receiving the redemption authorization from the ticketing server 116, the player interface device 606 transmits, to the game controller 108, a series of commands related to electronic transfer of cashable credits (e.g., AFT lock requests, AFT interrogation commands, AFT transfer requests, etc.). At least one of the funds transfer commands indicates the $20 value.

The flow 700 continues at processing block 714 where the game controller 108 adds gaming credits to a credit meter and then transmits a transfer completion response. For instance, in response to receiving the one or more funds transfer commands, the game controller 108 adds a number of cashable credits to the credit meter of the gaming machine 110. The number of cashable credits can depend on a game credit conversion factor associated with an accounting denomination value specified for the gaming machine 110. For example, if the accounting denomination is for five cents ($0.05), or in other words, the game credit conversion factor is five cents per game credit (e.g., $0.05/game credit), then the game controller 108 can multiply the $20 value by the $0.05/game credit conversion factor to obtain the number of cashable credits (e.g., one-hundred (100) cashable credits). In other embodiments, the game controller 108 does not perform a game credit conversion factor, but rather adds a number of credits equivalent to the funding request. For example, the game controller 108 adds twenty dollars ($20) of cashable credits to the credit meter For example, as illustrated in FIG. 7, the credit meter indicates an updated credit meter value 760B of “$20.” After adding the cashable credits to the credit meter, the game controller 108 transmits a transfer completion response that specifies that the game controller 108 was successfully funded.

Referring back to FIG. 7, the flow 700 continues at processing block 715, where, in response to receiving the transfer completion response, the player interface device 606 notifies the mobile application that the funding request was completed. In some embodiments, the mobile application presents an updated available-balance value 750B showing that the initial available-balance value 750A was reduced by the amount of the funding request (e.g., the initial available-balance value 750A was $20, but was reduced by $20, so the updated available-balance value 751B indicates $0).

The flow 700 continues at processing block 716 where the player interface device 606 notifies the ticketing server 116 that the virtual ticket was redeemed. For example, in response to detecting that the game controller 108 funded the credit meter, the player interface device 606 transmits a message to the ticketing server 116 to indicate the completion of the funding. In response to receiving the message from the player interface device 606, the ticketing server 116 is configured to close the record in the ticketing database 118 associated with the virtual ticket. In other words, the ticketing server marks the record as being paid-out according to slot accounting protocols.

FIG. 8 is schematic view of a gaming system according to at least some aspects of the disclosed concepts. Referring to FIG. 8, a gaming machine 810 includes game-logic circuitry 840 (e.g., securely housed within a locked box inside a gaming cabinet). The game-logic circuitry 840 includes a central processing unit (CPU) 842 connected to a main memory 844 that comprises one or more memory devices. The CPU 842 includes any suitable processor(s), such as those made by Intel and AMD. By way of example, the CPU 842 includes a plurality of microprocessors including a master processor, a slave processor, and a secondary or parallel processor. Game-logic circuitry 840, as used herein, comprises any combination of hardware, software, or firmware disposed in or outside of the gaming machine 810 that is configured to communicate with or control the transfer of data between the gaming machine 810 and a bus, another computer, processor, device, service, or network. The game-logic circuitry 840, and more specifically the CPU 842, comprises one or more controllers or processors and such one or more controllers or processors need not be disposed proximal to one another and may be located in different devices or in different locations. The game-logic circuitry 840, and more specifically a main memory 844, comprises one or more memory devices which need not be disposed proximal to one another and may be located in different devices or in different locations. The game-logic circuitry 840 is operable to execute all of the various gaming methods and other processes disclosed herein. The main memory 844 includes a wagering-game unit 846. In one embodiment, the wagering-game unit 846 causes wagering games to be presented, such as video poker, video blackjack, video slots, video lottery, etc., in whole or part.

The game-logic circuitry 840 is also connected to an input/output (I/O) bus 848, which can include any suitable bus technologies, such as an AGTL+ frontside bus and a PCI backside bus. The I/O bus 848 is connected to various input devices 850, output devices 852, and input/output devices 854.

By way of example, the output devices may include a primary display, a secondary display, and one or more audio speakers. The primary display or the secondary display may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 810. The gaming machine 810 can also include a touch screen(s) mounted over the primary or secondary displays, buttons on a button panel, a bill/ticket acceptor, a card reader/writer, a ticket dispenser, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, buttons, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The input/output devices 854 include one or more value input/payment devices and value output/payout devices. In order to deposit cash or credits onto the gaming machine 810, the value input devices are configured to detect a physical item associated with a monetary value that establishes a credit balance on a credit meter (e.g., credit meter 420 described in FIG. 4). The physical item may, for example, be currency bills, coins, tickets, vouchers, coupons, cards, and/or computer-readable storage mediums. The deposited cash or credits are used to fund wagers placed on the wagering game played via the gaming machine 810. Examples of value input devices include, but are not limited to, a coin acceptor, a bill/ticket acceptor (e.g., a bill validator), a card reader/writer, a wireless communication interface (e.g., wireless communication device 102) for reading cash or credit data from a nearby mobile device, and a network interface for withdrawing cash or credits from a remote account via an electronic funds transfer. In response to a cashout input that initiates a payout from the credit balance on the “credits” meter (e.g., credit meter 420 described in FIG. 4), the value output devices are used to dispense cash or credits from the gaming machine 810. The credits may be exchanged for cash at, for example, a cashier or redemption station. Examples of value output devices include, but are not limited to, a coin hopper for dispensing coins or tokens, a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

The I/O bus 848 is also connected to a storage unit 856 and an external-system interface 858, which is connected to external system(s) 860 (e.g., wagering-game networks, communications networks, etc.).

The external system(s) 860 includes, in various aspects, a gaming network, other gaming machines or terminals, a gaming server, a remote controller, communications hardware, or a variety of other interfaced systems or components, in any combination. In yet other aspects, the external system(s) 860 comprises a player's portable electronic device (e.g., cellular phone, electronic wallet, etc.) and the external-system interface 858 is configured to facilitate wireless communication and data transfer between the portable electronic device and the gaming machine 810, such as by a near-field communication path operating via magnetic-field induction or a frequency-hopping spread spectrum RF signals (e.g., Bluetooth, etc.).

The gaming machine 810 optionally communicates with the external system(s) 860 such that the gaming machine 810 operates as a thin, thick, or intermediate client. The game-logic circuitry 840—whether located within (“thick client”), external to (“thin client”), or distributed both within and external to (“intermediate client”) the gaming machine 810—is utilized to provide a wagering game on the gaming machine 810. In general, the main memory 844 stores programming for a random number generator (RNG), game-outcome logic, and game assets (e.g., art, sound, etc.)—all of which obtained regulatory approval from a gaming control board or commission and are verified by a trusted authentication program in the main memory 844 prior to game execution. The authentication program generates a live authentication code (e.g., digital signature or hash) from the memory contents and compares it to a trusted code stored in the main memory 844. If the codes match, authentication is deemed a success and the game is permitted to execute. If, however, the codes do not match, authentication is deemed a failure that must be corrected prior to game execution. Without this predictable and repeatable authentication, the gaming machine 810, external system(s) 860, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 842 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 842 when executing the game-outcome logic to determine a resultant outcome for that instance of the wagering game. The resultant outcome is then presented to a player of the gaming machine 810 by accessing the associated game assets, required for the resultant outcome, from the main memory 844. The CPU 842 causes the game assets to be presented to the player as outputs from the gaming machine 810 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 810 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 810 may include additional peripheral devices or more than one of each component shown in FIG. 8. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

FIG. 9 is shown a block diagram of a computer system 900 according to one or more embodiments. The computer system 900 includes at least one processor 942 coupled to a chipset 944, as indicated in dashed lines. Also coupled to the chipset 944 are memory 946, a storage device 948, a keyboard 950, a graphics adapter 952, a pointing device 954, and a network adapter 956. A display 958 is coupled to the graphics adapter 952. In one embodiment, the functionality of the chipset 944 is provided by a memory controller hub 960 and an I/O controller hub 962. In another embodiment, the memory 946 is coupled directly to the processor 942 instead of to the chipset 944.

The storage device 948 is any non-transitory computer-readable storage medium, such as a hard drive, a compact disc read-only memory (CD-ROM), a DVD, or a solid-state memory device (e.g., a flash drive). The memory 946 holds instructions and data used by the processor 942. The pointing device 954 may be a mouse, a track pad, a track ball, or another type of pointing device, and it is used in combination with the keyboard 950 to input data into the computer system 900. The graphics adapter 952 displays images and other information on the display 958. The network adapter 956 couples the computer system 900 to a local or wide area network.

As is known in the art, the computer system 900 can have different and/or other components than those shown in FIG. 9. In addition, the computer system 900 can lack certain illustrated components. In one embodiment, the computer system 900 acting as the virtual ticketing gateway 120 (FIG. 1) may lack the keyboard 950, pointing device 954, graphics adapter 952, and/or display 958. Moreover, the storage device 948 can be local and/or remote from the computer system 900 (such as embodied within a storage area network (SAN)). Moreover, other input devices, such as, for example, touch screens may be included.

The network adapter 956 (may also be referred to herein as a communication device) may include one or more devices for communicating using one or more of the communication media and protocols discussed above with respect to FIG. 1, FIG. 2, FIG. 3, FIG. 4, FIG. 5, FIG. 6, FIG. 7 or FIG. 8.

In addition, some or all of the components of this general computer system 900 of FIG. 9 may be used as part of the processor and memory discussed above with respect to the systems or devices described for FIG. 1, FIG. 2, FIG. 3, FIG. 4, FIG. 5, FIG. 6, FIG. 7 or FIG. 8.

In some embodiments, a gaming system may comprise several such computer systems 900. The gaming system may include load balancers, firewalls, and various other components for assisting the gaming system to provide services to a variety of user devices.

The computer system 900 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 948, loaded into the memory 946, and executed by the processor 942.

FIG. 2, FIG. 3, and FIG. 7 described by way of example above, represent data processing methods (e.g., algorithms) that correspond to at least some instructions stored and executed by a processor and/or logic circuitry associated with the virtual ticketing gateway 120 and/or with the player interface device 606. However other embodiments can utilize processors and/or logic circuitry of any of the devices described for FIG. 1, FIG. 2, FIG. 3, FIG. 4, FIG. 5, FIG. 6, FIG. 7, FIG. 8, or FIG. 9 to perform the above described functions associated with the disclosed concepts.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A method comprising:
detecting, by a processor via a wireless communication device communicatively coupled to a player interface device, a user input transmitted from a mobile device, wherein the player interface device is communicatively coupled to a gaming machine, wherein the mobile device is communicatively coupled to a third-party funding system via a telecommunications network, and wherein the user input is associated with a request to fund the gaming machine with an amount of monetary value;
in response to detecting the user input, obtaining, by the processor, a virtual ticket purchased, via the third-party funding system, from a ticketing server communicatively coupled to a casino network, wherein the virtual ticket is associated with a voucher identifier authorized by the ticketing server;
redeeming, by the processor using the voucher identifier, the virtual ticket, wherein in response to redeeming the virtual ticket, the ticketing server transmits, via the casino network, a funding authorization; and
in response to the receiving the funding authorization via the casino network, funding, by the processor via funds transfer, the gaming machine with the amount of monetary value.

2. The method of claim 1, further comprising, in response to detecting the user input, determining, by the processor, a security key and a mobile device identifier for the mobile device.

3. The method of claim 2, wherein the determining the security key and the mobile device identifier is via an application programming interface (API) communication between the player interface device and a mobile application running on the mobile device, and wherein the security key is one or more of a passcode or a personal identification number (PIN).

4. The method of claim 2, wherein the third-party funding system comprises a transaction server, and wherein the obtaining the virtual ticket comprises:
in response to the determining the mobile device identifier, transmitting, by the processor to the transaction server, a request to transfer the virtual ticket, wherein the request to transfer includes providing the mobile device identifier and the security key for a verification of the request to transfer; and
receiving the voucher identifier from the transaction server in response to the transaction server verifying the request to transfer.

5. The method of claim 4, wherein the redeeming the virtual ticket comprises:
transmitting, by the processor to the ticketing server, a redemption command for the virtual ticket using the voucher identifier, wherein the ticketing server generates a redemption authorization equivalent to the amount of monetary value, in response to receiving the redemption command; and
in response to transmitting the redemption command, receiving, from the ticketing server, the redemption authorization.

6. The method of claim 5, wherein the funding the gaming machine comprises, in response to receiving the redemption authorization, transmitting, by the processor, the funding authorization to the player interface device, wherein the player interface device is configured to initiate the funds transfer of the amount of monetary value to a game controller of the gaming machine.

7. The method of claim 6, wherein the processor is associated with a Slot Account System (SAS) host, wherein the redemption command comprises a first SAS command, and wherein the funds transfer comprises one or more second SAS commands.

8. The method of claim 4, wherein a copy of the mobile device identifier is stored in a transaction database record when the virtual ticket was purchased from the ticketing server, and wherein the transaction server verifies the request to transfer by determining that the mobile device identifier, as determined by the player interface device, is equivalent to the copy of the mobile device identifier stored in the transaction database record.

9. The method of claim 8 further comprising
generating, by the processor via the player interface device, a message indicating redemption of the amount of monetary value;
transmitting, by the processor via the wireless communication device, the message to the mobile device, wherein the mobile device is configured to present the message via a mobile application running on the mobile device; and
transmitting, by the processor via the player interface device, the message to a game controller of the gaming machine, wherein the game controller is configured to increase a credit meter with a number of gaming credits equivalent to the amount of monetary value.

10. The method of claim 1, wherein the funding the gaming machine comprises:
transmitting, by the processor via the casino network, the funding authorization for the amount of monetary value to the player interface device associated with the gaming machine,
wherein the player interface device is configured to perform the funds transfer.

11. The method of claim 10, wherein the funds transfer comprises one or more of an Advanced Fund Transfer (AFT) or an Electronic Funds Transfer (EFT).

12. A system comprising:
a network communication interface configured to connect to a casino network; and
a processor configured to execute instructions, which when executed perform operations that cause the system to:
detect, via a wireless communication device communicatively coupled to a player interface device, a user input transmitted from a mobile device, wherein the player interface device is communicatively coupled to a gaming machine, wherein the mobile device is communicatively coupled to a third-party funding system via a telecommunications network, and wherein the user input is associated with a request to fund the gaming machine with an amount of monetary value;
obtain, in response to detection of the user input, a virtual ticket purchased, via the third-party funding system, from a ticketing server communicatively coupled to the casino network, wherein the virtual ticket is associated with a voucher identifier authorized by the ticketing server;
redeem, using the voucher identifier, the virtual ticket, wherein in response to redemption of the virtual ticket, the ticketing server is configured to transmit, via the casino network, a funding authorization; and
in response to the receipt of the funding authorization via the casino network, fund, via funds transfer, the gaming machine with the amount of monetary value.

13. The system of claim 12, wherein the processor is configured to execute instructions, which when executed perform operations that cause the system to:
in response to detection of the user input, determine a security key and a mobile device identifier for the mobile device;
transmit, to the transaction server via communication network external to the casino network, a request to transfer the virtual ticket, wherein the request to transfer includes the mobile device identifier and the security key, wherein the transaction server verifies the request to transfer using the mobile device identifier and the security key; and
receive the voucher identifier from the transaction server in response to the verification of the request to transfer.

14. The system of claim 13, wherein the processor is configured to execute instructions, which when executed perform operations that cause the gaming system to determine the security key and the mobile device identifier is via an application programming interface (API) communication between the player interface device and a mobile application running on the mobile device, and wherein the security key is one or more of a passcode or a personal identification number (PIN).

15. The system of claim 12, wherein the processor is configured to execute instructions, which when executed perform operations that cause the system to:
transmit, to the ticketing server, a redemption command for the virtual ticket using the voucher identifier, wherein the ticketing server generates, in response to receipt of the redemption command, a redemption authorization equivalent to the amount of monetary value;
receive the redemption authorization from the ticketing server; and
in response to receipt of the redemption authorization, transmit the funding authorization to the player interface device, wherein the player interface device is configured to initiate the funds transfer for the amount of monetary value to a game controller of the gaming machine.

16. The system of claim 15, wherein the processor is associated with a Slot Account System (SAS) host, wherein the redemption command comprises a first SAS command, and wherein the funds transfer comprises one or more second SAS commands.

17. The system of claim 12, wherein the processor is configured to execute instructions, which when executed perform operations that cause the system to:
generate, via the player interface device, a message indicating redemption of the amount of monetary value;
transmit, by the processor via the wireless communication device, the message to the mobile device, wherein the mobile device is configured to present the message via a mobile application running on the mobile device; and
transmit, by the processor via the player interface device, the message to a game controller of the gaming machine, wherein the game controller is configured to increase a credit meter with a number of gaming credits equivalent to the amount of monetary value.

18. The system of claim 12, wherein the processor is configured to execute instructions, which when executed perform operations that cause the system to:
transmit, via the casino network, the funding authorization for the amount of monetary value to the player interface device, wherein the player interface device is configured to perform the funds transfer with a game controller of the gaming machine.

19. The system of claim 12, wherein the funds transfer comprises one or more of an Advanced Fund Transfer (AFT) or an Electronic Funds Transfer (EFT).
